(19) United States
(12) Patent Application Publication
(10) Pub. No.: US 2025/0010956 A1
(43) Pub. Date: Jan. 9, 2025

(54) Floating Wind Turbine with Floats Providing a Variable Center of Gravity

(71) Applicant: Vincent Loccisano, Wellesley, MA (US)

(72) Inventor: Vincent Loccisano, Wellesley, MA (US)

(73) Assignee: T-Omega Wind, Milton, MA (US)

(21) Appl. No.: 18/766,569

(22) Filed: Jul. 8, 2024

Related U.S. Application Data
(60) Provisional application No. 63/512,617, filed on Jul. 8, 2023.

(51) Int. Cl. B63B 35/44; B63B 39/03; F03D 13/25

(52) U.S. Cl. CPC B63B 35/44; B63B 39/03; F03D 13/256; B63B 2035/446; F05B 2240/93; F05B 2240/95

(57) ABSTRACT

A floating wind turbine is supported by floats with an upper cylindrical portion and a lower hull-shaped portion. The lower hull-shaped portion has a conical section with a bow formed on one side. Increased ballast in the floats provides a stable platform for the turbine in operation while decreased ballast in the floats exposes the bow portion, facilitating towing.

### TECHNICAL FIELD

The present disclosure relates in general to wind turbines and more specifically to shallow floats supporting offshore wind turbines and increasing the speed of towing at sea.

### BACKGROUND OF THE INVENTION

Utility-scale, offshore floating wind turbines are constructed in ocean locations of various depths. Wind turbines that are anchored to the ocean bottom are designed to be stationary. In waters shallower than 60 m, the turbines are single-tower systems mounted to the sea bed. In deeper waters, the turbines float, employing floats, spar buoys, semi-submersible platforms, tension legs, or large-area barge-type constructions to stabilize them.

In the context of this disclosure, a float supports a floating wind turbine. Its hull shape depends on strength, weight, displacement, wave motion, and behavior during towing. Float hulls may be shaped with a square end like that of a scow barge, or a pointed surface like that of a sailboat racing hull, or a cylindrical shape like that of a harbor buoy.

While easier to tow than heavier turbines, floating turbines with shallow drafts are more susceptible to tossing in waves. The rotor shaft and bearing assembly of a shallow-draft turbine must be capable of surviving greater loads and accelerations than those of deep-draft designs. Increasing the motion-tolerance of the rotor is less complicated and less costly than curtailing rotor motion. This makes shallow-draft designs economically and technically preferable, providing the floats meet mandatory floating-structure requirements.

Floating structures are regulated by an “intact stability” requirement of International Maritime Organization rules. To test for this, a structure is tipped (in computer simulation) to angles up to 30 degrees. Its tendency to return upright (its restoring moment) is calculated for each angle. The restoring moment divided by system weight is referred to as its “moment arm” or “righting arm,” and the curve of righting arm versus tip angle is subject to requirements including.
1. The greatest righting arm must appear at tip angles of 15 degrees or greater. That means it must become increasingly difficult to tip the structure until 15 degrees is reached. As the tip angle increases beyond 15 degrees it is permitted to be easier to tip.
2. The righting arm must remain positive to tip angles of at least 30 degrees. That means that a structure tipped to 30 degrees and released will right itself.

When tipped, a structure supported by widely separated shallow-draft floats will have either the high-side float rising out of the water, or the low-side float sinking into the water. A structure with a center of mass above the float plane and floats spaced more than their width or height will therefore be unable to satisfy the intact stability requirement. When a tip angle is imposed, floats on one side may leave the water. The maximum value of the righting arm occurs as soon as floats leave the water. This is commonly at a tip angle significantly less than 15° and in some cases close to 5°. Alternatively, when the angle of tip is increased, the floats on one side may sink. In this case the righting arm decreases as the tip angle increases; therefore the maximum righting arm occurs as soon as the float submerges, commonly at a tip angle of 5°, well below 15°.

To ensure the angle of maximum righting arm exceeds 15° there must be continued interaction with the water of the rising or submerging float. For this reason it is necessary to design floats to be taller than needed to carry their intended weight, with a compact (low-cost) design.

One skilled in the art understands that many fluids are lighter than water and that air is one fluid that is lighter than water. Many fluids may be used to move ballast into, or out of, a buoy by displacement. The term lighter-than-water fluid includes air. Air is a fluid that is lighter than water, although other fluids may also be used.

### SUMMARY OF THE INVENTION

A floating structure for towably supporting an offshore wind turbine uses floats of various configurations. The structure enables launching an offshore wind turbine from a shallow port as well as towing to a mooring. Various iterations are designed to prevent the floats from swamping during towing at differing speeds.

In an example embodiment, a float has a structure beneath the water surface that effectively increases the distance over which a rising float interacts with the water. A cylindrical upper portion is joined to a conical lower portion. The cylindrical upper portion has a bulkhead to reduce sloshing on the interior of the buoy. The conical lower portion has a bow formed on a front end. A pump moves a lighter-than-water fluid such as air, into and out of the hollow interior of the buoy. One skilled in the art understands that moving a fluid that is lighter than water, into the buoy will displace ballast and moving lighter-than-water fluid out of the buoy will pull in ballast. In some embodiments the bottom of the buoy is open and ballast flows freely in as the pump removes lighter-than-water fluid from the upper cylindrical portion of the buoy. One skilled in the art understands that various fluids that are lighter than water may be used to increase floatation and decrease ballast in a buoy.

In other embodiments a valve works in conjunction with the pump and opens when the pump moves lighter-than-water fluid into or out of the interior of the buoy. In some embodiments the valve is controlled by a controller that is electrically coupled to both the pump and valve; opening the valve when ballast is moved into or out of the buoy. In one example, the valve may be controlled by a control circuit and held in a closed position while lighter-than-water fluid is pumped into the interior of the buoy raising the pressure in the buoy above atmospheric pressure. Greater than atmospheric pressure may provide increased structure and may also be used to detect leaks.

In other embodiments the valve is a pressure release valve that automatically opens at a positive or negative pressure threshold when the pump pumps lighter-than-water fluid into the buoy, thus increasing the pressure inside the buoy or pumps lighter-than-water fluid out of the buoy thus decreasing pressure on the interior of the buoy.

### BRIEF DESCRIPTION OF DRAWINGS

FIG. 1 is a perspective view of an example floating turbine with shallow floats.

FIG. 2 is a perspective view of a float.

FIG. 3 is a section view of the float of FIG. 2.

FIG. 4 is a perspective view of an iteration of a float.

FIG. 5 is a section view of the float of FIG. 4.

FIG. 6 is a perspective view of a set of buoys.

FIG. 7 is a perspective view of a set of buoys.

FIG. 8 is a section view of an iteration of the embodiment.

### DETAILED DESCRIPTION

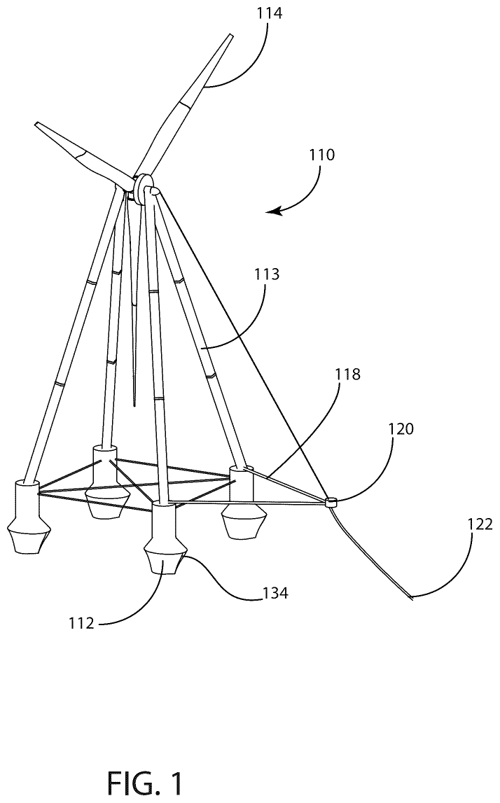

In FIG. 1, a floating wind turbine 110 has a rotor 114 that is supported by legs 113 that are supported by floats 112 which are further braced by lower struts 118. The lower struts join to a hitch point 120 which is joined to a mooring line 122. Floats 112 have a tall cylindrical upper portion 116 and a conical lower portion 124 in a hull form 134. Floats are normally ballasted to stabilize the turbine. Pressurizing the floats with lighter-than-water fluid to remove the ballast allows the float to rise from the water, exposing the bow 134, making it easier to tow.

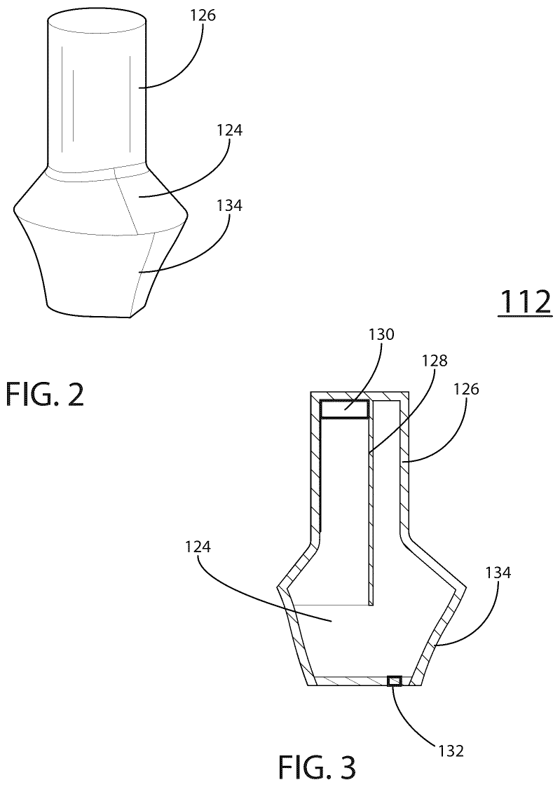

In FIG. 2 and FIG. 3: in one embodiment the floats 112 have a cylindrical upper portion 126 and a lower hull-shaped portion 124. The lower hull-shaped portion 124 is conical with a bow 134 formed on one side. In some embodiments, bulkheads 128 are formed on the inside of the upper cylindrical portion 126 to keep ballast water from sloshing. In the example embodiment 112, a pump 130 and valve 132 control the amount of water ballast and fluid pressure inside the float 112. In some embodiments the valve 132 may be electronically controlled and electronically coupled with the pump 130 to open when the pump is pumping lighter-than-water fluid into, or out of, the float. In other embodiments the valve 132 is a pressure release valve that is normally held closed under tension and opens when a pressure threshold sufficient to overcome the tension, is reached. When sufficiently ballasted, the water level may reach to the cylindrical portion 126, lowering the center of gravity of the turbine in the water. One skilled in the art understands that a relatively lower center of gravity with maximum ballast provides a stable operating condition in which turbine movement is minimized. In some embodiments, the pump 130 and valve 132 on each of the floats 112 (FIG. 1) are electronically coupled to a control unit in the legs 113 (FIG. 1) to maintain the turbine 110 in a substantially level orientation. In one example, as one float rises out of the water, the pump removes lighter-than-water fluid thus drawing water in and so, ballast is increased. As another float subsequently sinks past a threshold, lighter-than-water fluid is pumped in, forcing water out and so, ballast is decreased. When the turbine is towed toward or away from shore, lighter-than-water fluid is pumped into the floats to remove ballast, exposing the bow 134 to the surface of the water for faster towing. As a turbine 110 (FIG. 1) tips, it forces a number of buoys beneath the surface of the water wherein a compressible gas, such as air, in the cylindrical upper portion 126 is compressed, providing a damping effect. The damping effect occurs as a buoy 112 with compressible gas is moved under the water and the water pressure causes the gas to compress.

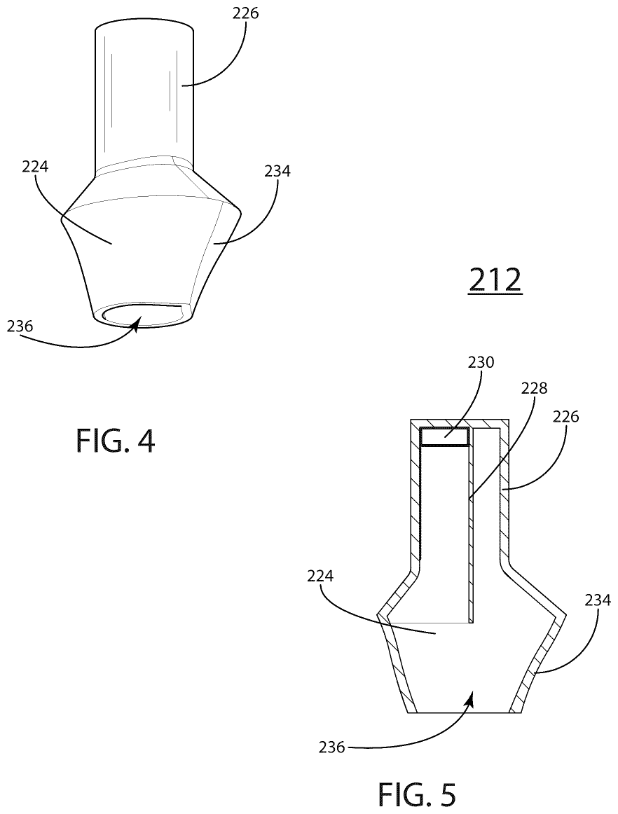

In FIG. 4 and FIG. 5: In another embodiment, floats 212 have an upper cylindrical portion 226 and a lower, hull-shaped portion 224. The lower, hull-shaped portion 224 has a conical section with an open bottom 236 and a bow 234 formed on one side. In some embodiments bulkheads 228 are formed on the inside of the upper cylindrical portion 226 to keep ballast water from sloshing. In the example embodiment 212, a pump 230 controls the amount of water ballast and lighter-than-water fluid pressure inside the float 212 by pumping lighter-than-water fluid into the upper cylindrical portion 226, pushing water out of the open bottom 236. When sufficiently ballasted, the water level may reach to the cylindrical portion 226, lowering the center of gravity of the turbine in the water. One skilled in the art understands that a relatively lower center of gravity with maximum ballast provides a stable operating condition in which the movement of the turbine is minimized.

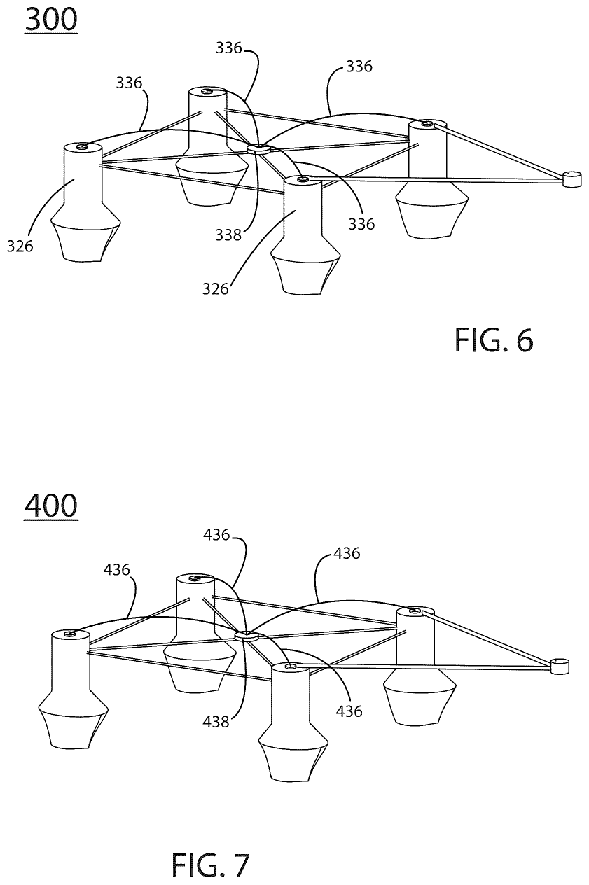

FIG. 6 illustrates an iteration of the embodiment wherein conduits 236 join upper cylindrical portions 326 of each buoy to a central manifold 338. Fluid communication from the manifold to each buoy cylindrical upper portion 326 maintains equal internal pressure between each buoy.

FIG. 7 illustrates an iteration of the embodiment 400 wherein conduits 436 join cylindrical upper portions 426 of each buoy to a central manifold 438 that houses a set of computer controlled valves and a central pump so that the fluid pressure in each buoy may be independently controlled by a central controller.

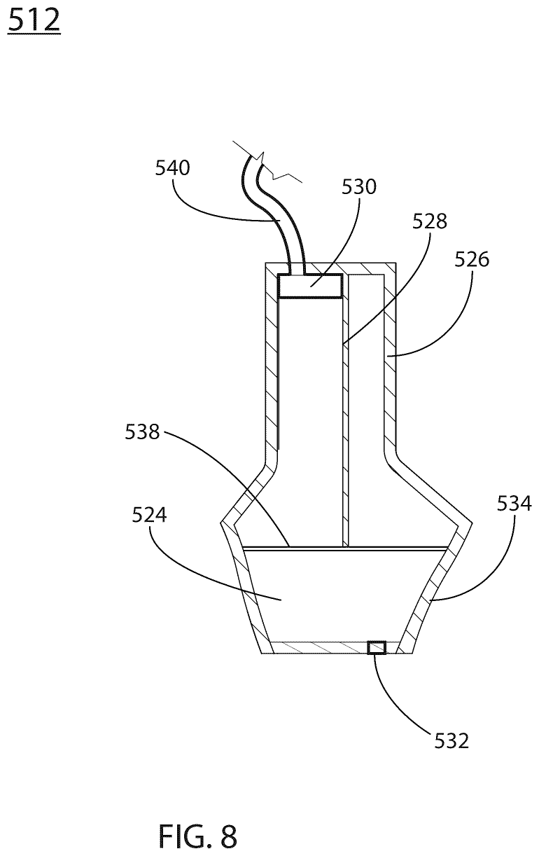

FIG. 8 illustrates an iteration of the embodiment 512. Floats 512 have a cylindrical upper portion 526 and a conical lower portion 524. The lower hull-shaped portion 524 is conical with a bow 534 formed on one side. In some embodiments, bulkheads 528 are formed on the inside of the cylindrical upper portion 526 to keep fluids from sloshing. In the example embodiment 512, a pump 530 and valve 532 control the amount of ballast and fluid pressure inside the float 512. In some embodiments the valve 532 may be electronically controlled and electronically coupled with the pump 530 to open when the pump is pumping lighter-than-water fluid into, or out of, the float. A membrane 538 resides between the cylindrical upper portion 526 and the conical lower portion 524. A conduit 540 extends to a reservoir filled with lighter-than-water fluid. In an example embodiment the lighter-than-water fluid is oil. Oil may be pumped into, or out of, the cylindrical upper portion 526. The membrane 538 prevents oil from mixing with water and the oil is retained between the conduit 540 and a reservoir. A lighter-than-water fluid provides floatation without damping as the fluid is not compressible. As the buoy moves beneath the surface of the water it provides floatation, however, the fluid is not compressible so no damping effect is appreciated.

1. A shallow draft float for a wind turbine comprising:
a cylindrical upper portion having an exterior and a hollow interior; and
a conical lower portion having a top, bottom front and back, exterior and hollow interior; and
a bow formed on the front of said conical lower portion; and
a bulkhead formed in the hollow interior of the cylindrical upper portion.

2. The shallow draft float of claim 1 wherein;
the conical lower portion has a hollow interior that is in fluid communication with said cylindrical upper portion hollow interior.

3. The shallow draft float of claim 1 wherein;
the upper portion hollow interior and the conical lower portion hollow interior reside at atmospheric pressure.

4. The shallow draft float of claim 1 further comprising:
a conduit in fluid communication with said cylindrical upper portion of at least two shallow draft floats and further in fluid communication with a central manifold;
wherein
pressure is equalized between said at least two shallow draft floats.

5. The shallow draft float of claim 1 further comprising:
a conduit in fluid communication with said cylindrical upper portion of at least two shallow draft floats and further in fluid communication with a central manifold; and
said central manifold is controlled by a computer operated controller; wherein
the relative buoyance of each of said at least two shallow draft floats are independently controlled.

6. The shallow draft float of claim 2 further comprising:
a pump fixedly engaged with said cylindrical upper portion and in fluid communication between the exterior and hollow interior of the cylindrical upper portion and conical lower portion; wherein
lighter-than-water fluid pumped into the hollow interior of said cylindrical upper portion displaces ballast; lighter-than-water fluid pumped out of the hollow interior of said cylindrical upper portion draws ballast in to the hollow interior of said cylindrical upper portion and said conical lower portion.

7. The shallow draft float of claim 1 wherein;
the pump is configured to increase the pressure in the upper portion hollow interior and the conical lower portion hollow interior, above atmospheric pressure.

8. The shallow draft float of claim 1 wherein:
said conical lower portion bottom has an opening.

9. The shallow draft float of claim 4 further comprising:
a valve fixedly engaged with said conical lower portion bottom and in fluid communication between the conical lower portion exterior and hollow interior;
wherein
the valve opens to release ballast as said pump pumps lighter-than-water fluid into said upper cylindrical portion hollow interior and opens to intake ballast when said pump pumps lighter-than-water fluid out of said upper cylindrical portion hollow interior.

10. The shallow draft float of claim 9 wherein;
said valve is held normally closed; and
said lighter-than-water fluid is a compressible gas; wherein;
movement of said shallow draft float under water causes said compressible gas to compress providing a damping effect as increased movement under water causes increased floatation.

11. The shallow draft float of claim 9 wherein:
said valve is in electrical communication with a controller that is further in electrical communication with said pump; wherein
the valve is open as the pump is engaged to move ballast in or out of said upper cylindrical and said lower conical hollow interior.

12. The shallow draft float of claim 9 wherein;
said valve is a pressure release valve; wherein
a preset pressure in said cylindrical upper portion hollow interior and said lower conical portion hollow interior opens the pressure release valve.

13. A shallow draft float for a wind turbine comprising:
a cylindrical upper portion having an exterior and a hollow interior; and
a conical lower portion having a top, bottom front and back, exterior and hollow interior; and
a bow formed on the front of said conical lower portion; and
a bulkhead formed in the hollow interior of the cylindrical upper portion; and
a membrane extending between said cylindrical upper portion and said conical lower portion.

14. The shallow draft float of claim 13 further comprising:
a pump fixedly engaged with said cylindrical upper portion and in fluid communication a conduit extending from the cylindrical upper portion hollow interior and a reservoir providing a lighter-than-water fluid; wherein
lighter-than-water fluid pumped into the hollow interior of said cylindrical upper portion displaces ballast; lighter-than-water fluid pumped out of the hollow interior of said cylindrical upper portion draws ballast in to the hollow interior of said cylindrical upper portion and said conical lower portion.

15. The shallow draft float of claim 13 further comprising:
a valve fixedly engaged with said conical lower portion bottom and in fluid communication between the conical lower portion exterior and hollow interior;
wherein the valve opens to release ballast as said pump pumps lighter-than-water fluid into said upper cylindrical portion hollow interior and opens to intake ballast when said pump pumps lighter-than-water fluid out of said upper cylindrical portion hollow interior.

16. The shallow draft float of claim 15 wherein;
said lighter-than-water fluid is a non-compressible fluid.
